(19) United States
(12) Patent Application Publication
(10) Pub. No.: US 2012/0143901 A1
(43) Pub. Date: Jun. 7, 2012

(54) SYSTEM AND METHOD FOR GENERATING MULTI-PLAYLIST

(75) Inventor: Yi-Chun Wang, Taipei (TW)

(73) Assignee: TECO ELECTRIC & MACHINERY CO., LTD., Taipei (TW)

(21) Appl. No.: 13/085,613

(22) Filed: Apr. 13, 2011

(30) Foreign Application Priority Data
Dec. 2, 2010 (TW) 099141984

(51) Int. Cl. G06F 17/30

(52) U.S. Cl. 707/769; 707/E17.014

(57) ABSTRACT

A system and a method for generating a multi-playlist are disclosed. The system includes a search module and an analysis module. The search module receives an original playlist including an original multimedia content. The search module searches a related multimedia content, relating to the original multimedia content, according to a search condition. The analysis module analyzes the related multimedia content, and generates a related playlist according to the original multimedia content and the related multimedia content.

This application claims the benefit of Taiwan application Serial No. 99141984, filed Dec. 2, 2010, the subject matter of which is incorporated herein by reference.

### BACKGROUND OF THE INVENTION

1. Field of the Invention

The invention relates in general to a system for generating a playlist, and more particularly to a system and a method for generating a multi-playlist.

2. Description of the Related Art

At present, Internet Protocol Television (IPTV) is one of new generation of Internet application services. The governments of various countries support the investments and the gradual popularization of the broadband Internet, the television is no longer a unidirectional propagation information provider, and the consumer himself/herself can choose to watch the desired program and cannot be restricted to the watching of the television program at the specific time.

FIG. 1 (Prior Art) is a schematic illustration showing a conventional original playlist. As shown in FIG. 1, the program contents of the IPTV come from the Internet, and the multimedia contents are classified and then arranged as an original playlist 110, an original playlist 120, an original playlist 130 and an original playlist 140 according to the condition of “most popular”, “most recent”, “featured videos” or “favorite”, as shown in FIG. 1. After the user chooses one of the original playlists 110, 120, 130 and 140, the IPTV can randomly or sequentially select, from the playlists, one multimedia content to play. For example, the IPTV can randomly or sequentially select, from the original playlist 110, a multimedia content A13c to play. After the multimedia content A13c is completely played, the IPTV further randomly or sequentially selects, from the original playlist 110, another multimedia content, such as a multimedia content M7, to play.

However, because the multimedia content comes from the Internet, no specific order relationship exists between the multimedia contents of the original playlist. So, the user often cannot see the coherent programs and frequently has the incoherent feelings. In addition, the IPTV cannot open a channel for a certain program because the programs are changing with each passing day and IPTV is not a long term business. In addition, the user's preferred multimedia contents are not completely the same, and the expectations and requirements of each consumer cannot be easily satisfied.

### SUMMARY OF THE INVENTION

The invention is directed to a system and a method for generating a multi-playlist. When the user is watching a certain multimedia content, the invention can automatically search the related multimedia content for the user to watch the related multimedia content easily.

According to a first aspect of the present invention, a multi-playlist generating system including a search module and an analysis module is provided. The search module receives an original playlist comprising an original multimedia content, and searches a related multimedia content, relating to the original multimedia content, according to a search condition. The analysis module analyzes the related multimedia content and generates a related playlist according to the original multimedia content and the related multimedia content.

According to a second aspect of the present invention, a multi-playlist generating method is provided. The multi-playlist generating method includes the following steps. An original playlist comprising an original multimedia content is received, and a related multimedia content, relating to the original multimedia content, is searched according to a search condition. The related multimedia content is analyzed and a related playlist is generated according to the original multimedia content and the related multimedia content.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 (Prior Art) is a schematic illustration showing a conventional original playlist.

FIG. 2 is a schematic illustration showing a multi-playlist generated according to a first embodiment.

FIG. 3 is a block diagram showing a multi-playlist generating system.

FIG. 4 is a flow chart showing a multi-playlist generating method.

FIG. 5 is a schematic illustration showing a notification bar 510 of a related playlist appeared in a played frame.

FIG. 6A is a schematic illustration showing a first server and a first device end.

FIG. 6B is a schematic illustration showing a second server and a second device end.

FIG. 7 is a schematic illustration showing a multi-playlist according to a second embodiment.

FIG. 8 is a schematic illustration showing a setting frame for a predetermined time.

FIG. 9 is a schematic illustration showing a setting frame for a ratio of the predetermined time to a total play time.

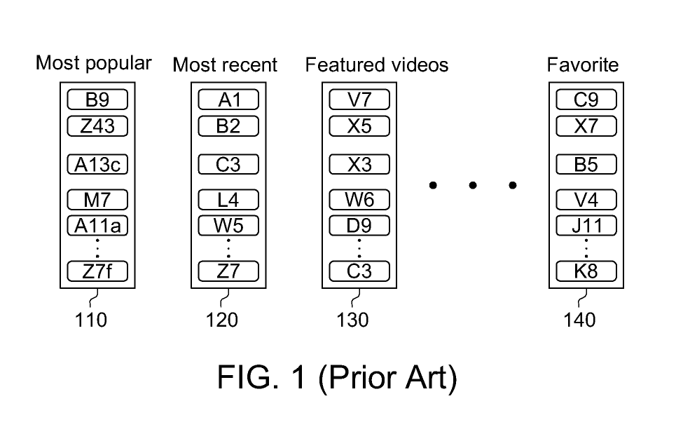

### DETAILED DESCRIPTION OF THE INVENTION

In order to make the user find and watch the desired multimedia content more conveniently, the following embodiments provide a multi-playlist generating system and a multi-playlist generating method. The multi-playlist generating system includes a search module and an analysis module. The search module receives an original playlist, comprising an original multimedia content, and searches a related multimedia content, relating to the original multimedia content, according to a search condition. The analysis module analyzes the related multimedia content, and generates a related playlist according to the original multimedia content and the related multimedia content.

The multi-playlist generating method includes the steps of: receiving an original playlist, comprising an original multimedia content, and searches a related multimedia content, relating to the original multimedia content according to the search condition; and analyzing the related multimedia content and generating a related playlist according to the original multimedia content and the related multimedia content.

### First Embodiment

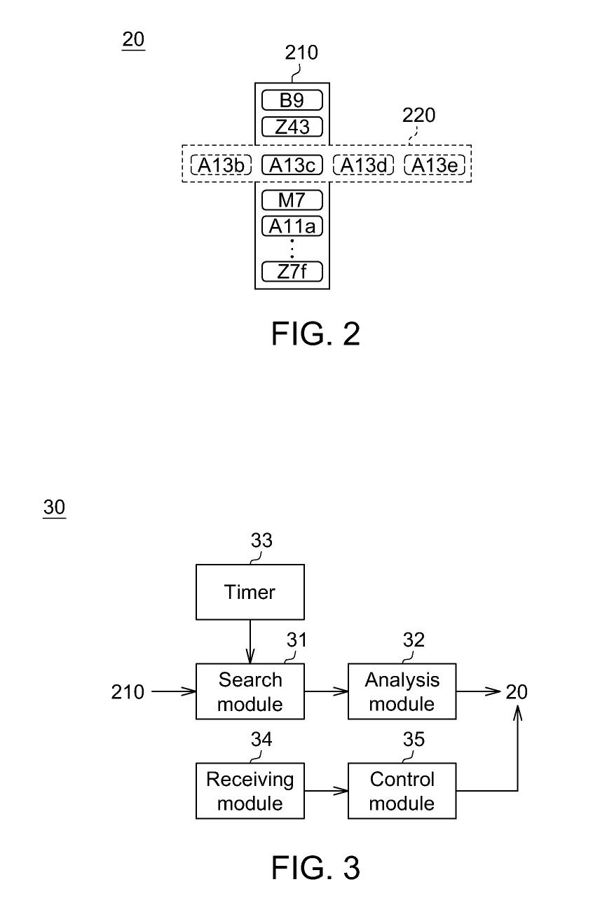

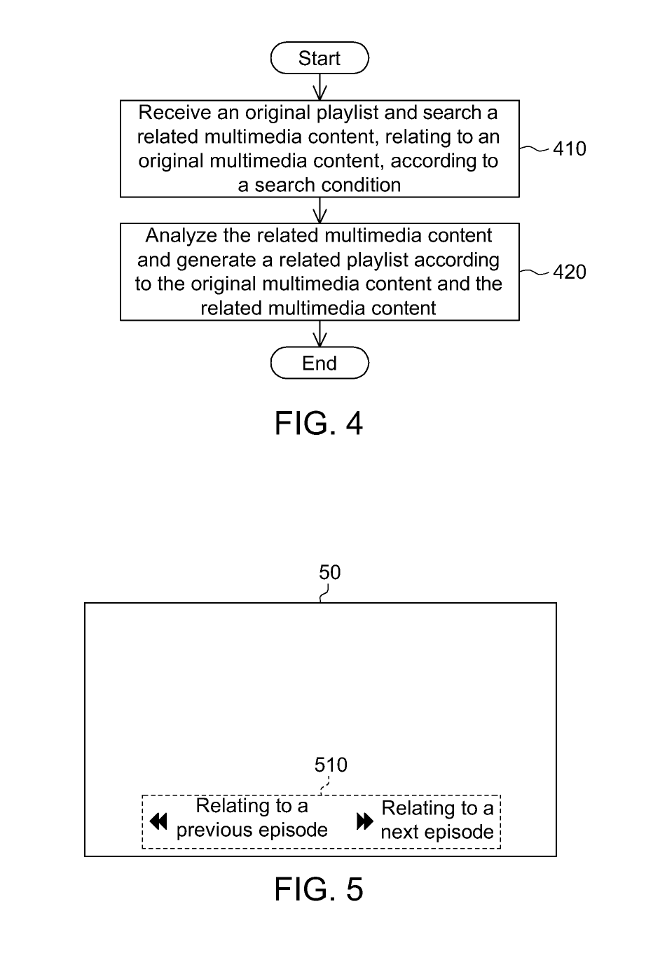

Please refer to FIGS. 2 to 4. FIG. 3 is a block diagram showing a multi-playlist generating system 30. FIG. 4 is a flow chart showing a multi-playlist generating method. FIG. 2 is a schematic illustration showing a multi-playlist generated according to a first embodiment. The multi-playlist generating system 30 includes a search module 31 and an analysis module 32, wherein the aspects of the search module 31 and the analysis module 32 are not restricted to the actual hardware, and may also be the program software. For example, a processor executes a program to implement the multi-playlist generating system 30. The multi-playlist generating system 30 performs the multi-playlist generating method to generate a multi-playlist 20 according to an original playlist 210. In this embodiment, the original playlist 210 includes several original multimedia contents, such as B9, Z43, A13c, M7, A11a, Z7f and the like. It is to be specified that the multimedia content is not restricted to the actually existing video-audio content, and may also be a website address link corresponding to a video-audio content. The multi-playlist generating method includes the following steps.

First, as shown in step 410, the search module 31 receives the original playlist 210, and searches several related multimedia contents, relating to the original multimedia content A13c, according to the search condition. The related multimedia contents may be, for example, related multimedia contents A13b, A13d, A13e and the like. The search condition may be, for example, one or a combination of a program name, an uploader name, and a website address, and the search condition is built in the multi-playlist generating system 30, for example. In addition, the multi-playlist generating system 30 is built with several sets of search conditions for the user to choose. For example, the original multimedia content A13c may be, for example, a paragraph (c) of a 13^{th} episode of a Japanese TV drama, and the search module 31 can regard the program name of the original multimedia content A13c as the search condition, and searches the related multimedia contents A13b, A13d and A13e, which are respectively a paragraph (b) of the 13^{th} episode of the Japanese TV drama, a paragraph (d) of the 13^{th} episode of the Japanese TV drama and a paragraph (e) of the 13^{th} episode of the Japanese TV drama according to the search condition. The multi-playlist generating method can directly perform the step 420 after the step 410 is finished. In addition, when the search module 31 does not successfully perform the search, the search will be performed again, and the number of searches of the search module 31 serves as the judgement condition regarding whether to perform the step 420 or not. For example, the step 420 can be performed only when the number of searches of the search module 31 is smaller than a predetermined number of searches and the search succeeds.

Next, as shown in step 420, the analysis module 32 analyzes the related multimedia contents A13b, A13d and A13e, and generates a related playlist 220 according to the original multimedia content A13c and the related multimedia contents A13b, A13d and A13e. For example, the real links of the multimedia content A13b, the related multimedia content A13d and the related multimedia content A13e do not necessarily exist, and the related multimedia content A13b, the related multimedia content A13d and the related multimedia content A13e can not necessarily to be played. So, it is possible to further ensure that the related multimedia contents listed in the related playlist 220 can be normally played through the analysis module 32, which analyzes the reliabilities and the real links of the related multimedia content A13b, the related multimedia content A13d and the related multimedia content A13e. The analysis module 32 can generate the multi-playlist 20 of FIG. 2 according to the original playlist 210 and the related playlist 220.

After the step 420 completes the analysis, if the analysis module 32 analyzes that the related multimedia contents A13b, A13d and A13e are not the valid website address link, then the search module 31 again searches the program of an invalid link. For example, if the analysis module 32 analyzes that the related multimedia content A13d is the invalid link, then the search module 31 again searches the other links according to the result of the related multimedia content A13d to ensure that the valid website address link of the related multimedia content A13d can be obtained.

It is to be specified that, in the multimedia content, one program is usually divided into several fragments, such as the related multimedia content A13b, the original multimedia content A13c, the related multimedia content A13d and the related multimedia content A13e shown in FIG. 2, due to the file size and the bandwidth resource. Because number of requested times of each fragment and the popularity are not necessarily the same, the front and rear paragraphs of the same category do not necessarily have the associated content over the Internet, and the consumer cannot sequentially watch the coherent programs in the conventional IPTV. However, the multi-playlist generating system 30 of the invention can search the related fragment, and list the related information in the related playlist, so that the consumer can easily watch the coherent programs.

Please refer to FIGS. 3 and 5. FIG. 5 is a schematic illustration showing a notification bar 510 of a related playlist appeared in a played frame. The multi-playlist generating system 30 may further include a receiving module 34 and a control module 35. The control module 35 associates the related multimedia content with the operation message, and controls the play content in the related playlist 220 according to the operation message. It is to be specified that the operation message is generated when the user operates keys of a remote controller, a television, a computer or a set top box. In addition, the operation message may also be generated when the user operates a touch screen. The receiving module 34 can receive the operation message, inputted by the user, and transfer the operation message to the control module 35.

For the sake of illustration, the operation message is generated when the user operates the hotkey of the remote controller in the following example. The control module 35 associates the related multimedia content in the related playlist 220 with the hotkey of the remote controller. For example, the control module 35 associates the related multimedia content A13b and the related multimedia content A13d in the related playlist 220 with the [symbol] key and the [symbol] key on the remote controller, respectively. When the playing of the original multimedia content A13c is about to be finished, the played frame 50 of the original multimedia content A13c appears the notification bar 510. The user can obtain the related multimedia content from the display of the notification bar 510, and the notification bar 510 displays that the user presses the [symbol] key on the remote controller to watch the related multimedia content A13b cohering the original multimedia content A13c, and presses the [symbol] key on the remote controller to watch the related multimedia content A13d cohering the original multimedia content A13c. The user can watch the related multimedia content A13b or the related multimedia content A13d after pressing the [symbol] key or [symbol] key on the remote controller. Furthermore, when the user does not want to watch the related multimedia content in the related playlist 220, he or she can press the ▴ key on the remote controller to watch the original multimedia content Z43 in the original playlist 210. Alternatively, the user can press the ▴ key on the remote controller to watch the original multimedia content M7 in the original playlist 210. Because the operation is very simple and intuitive, the convenience in use can be significantly enhanced. In addition, the related multimedia content of the related playlist 220 is switched using the [symbol] key and [symbol] key, and the original multimedia content of the original playlist is switched using the ▴ key and ▾ key. According to this key configuration, the user can easily switch between the original playlist 210 and the related playlist 220. This embodiment only discloses one key configuration, but is not limited thereto.

In addition, the multi-playlist generating system 30 may also include a timer 33, which is implemented by a processor executing a program. The timer 33 records the play time of the original multimedia content A13c. The search module 31 searches the related multimedia content A13b, the related multimedia content A13d and the related multimedia content A13e only when the play time of the original multimedia content A13c reaches a predetermined time. It is to be specified that the play time of the original multimedia content A13c represents the time length from the time of starting playing the original multimedia content A13c to the current time. In addition, the time length from the time of starting playing the original multimedia content A13c to the time of ending is referred to the total play time of the original multimedia content A13c.

The predetermined time may be adjusted according to the requirement, and the invention is not particularly restricted thereto. For example, the predetermined time may be set as ⅖ or ⅗ of the total play time of the original multimedia content A13c. When the play time of the original multimedia content A13c watched by the user reaches a predetermined time, it represents that the user is very interested in the original multimedia content A13c. So, the user extremely possibly desires to watch the related multimedia content of the original multimedia content A13c. Thus, the timer is adopted to record the play time of the original multimedia content A13c, so that it is possible to judge whether the user is interested in the original multimedia content A13c to prevent the search module 31 from searching the multimedia content, which is not interested by the user.

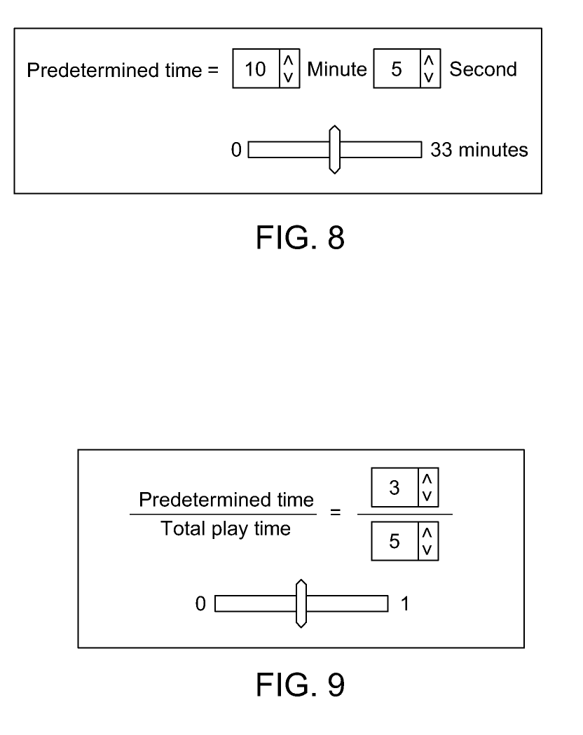

Please refer to FIGS. 8 and 9. FIG. 8 is a schematic illustration showing a setting frame for a predetermined time. FIG. 9 is a schematic illustration showing a setting frame for a ratio of the predetermined time to a total play time. However, the ratio of the predetermined time to the total play time of the original multimedia A13c is only one of various aspects, which does not intend to restrict the invention. For example, in FIG. 8, the predetermined time may also be a constant value, which may be set by the user, so that the user can determine the predetermined time according to his/her own watching habit. In addition, as shown in FIG. 9, the ratio of the predetermined time to the total play time may also be further determined by the user.

For the sake of illustration, one original playlist and one related playlist in FIG. 2 are described as an example. However, the invention is not restricted thereto, and the multi-playlist may also have multiple related playlists. For example, the search module 31 may further regard the uploader name and the program name of the original multimedia content A13c as the search condition, and several searches for the multimedia contents are individually performed according to the uploader name and the program name. The analysis module 32 generates two related playlists according to the multimedia content relating to the uploader name and the program name, respectively. In other words, the multi-playlist used in the invention may also include one original playlist and several related playlists.

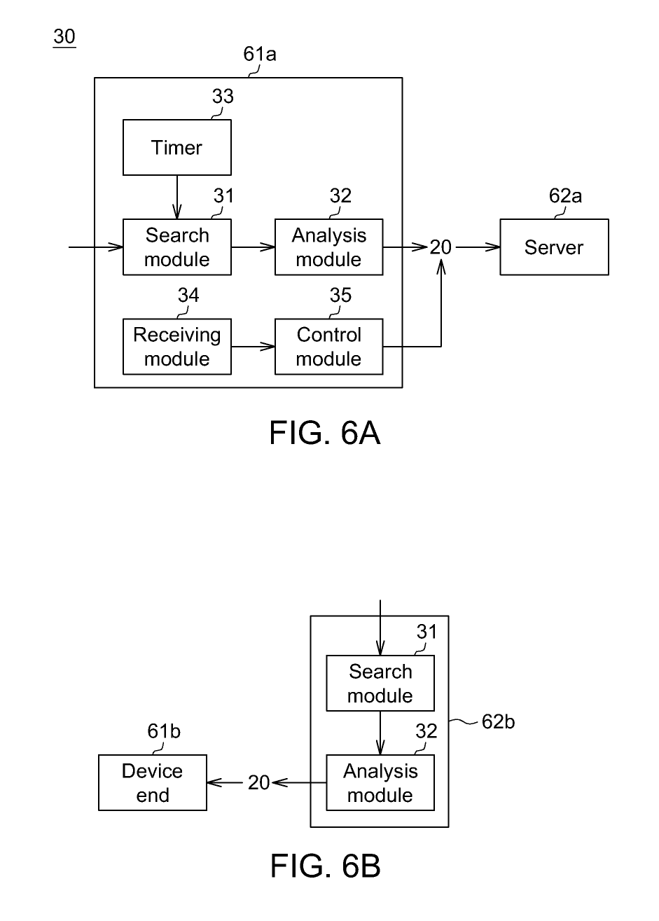

Please refer to FIGS. 2 and 6A. FIG. 6A is a schematic illustration showing a first server and a first device end. The search module 31, the analysis module 32, the timer 33, the receiving module 34 and the control module 35 of the multi-playlist generating system 30 are disposed on a device end 61a, which is, for example, a universal serial bus (USB) device, a mobile phone, a television, a computer or a set top box (STB). The server 62a is a server of a system provider. The device end 61a receives the original playlist, provided from the server 62a, and generates the related playlist according to the original playlist.

Please refer to FIGS. 2 and 6B. FIG. 6B is a schematic illustration showing a second server and a second device end. In addition, the search module 31 and the analysis module 32 of the multi-playlist generating system 30 may also be disposed in the server 62b, which generates the related playlist and then outputs the related playlist to the device end 61a. The device end 61b is, for example, a universal serial bus (USB) device, a mobile phone, a television, a computer or a set top box (STB), and the server 62b is the server of the system provider. Because the server 62b has the powerful computing power, it can quickly search the related multimedia content and generate the related playlist.

### Second Embodiment

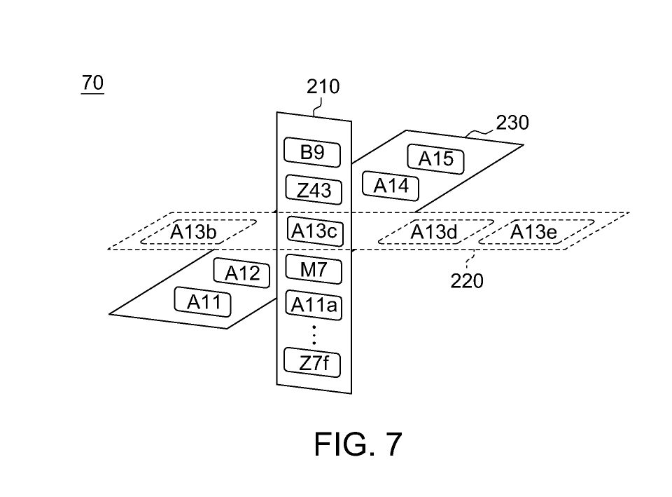

FIG. 7 is a schematic illustration showing a multi-playlist according to a second embodiment. In the first embodiment, the original multimedia content A13c, the related multimedia content A13b, the related multimedia content A13d and the related multimedia content A13e are several multimedia fragments of the same episode. However, the invention is not restricted thereto. The original multimedia content and the related multimedia content may also be different episode numbers in one program. For example, the original multimedia content A13c is a paragraph (c) of the 13^{th} episode of the Japanese TV drama. The search module 31 can regard the program name of the original multimedia content A13c as the search condition, and search the related multimedia content A11, the related multimedia content A12, the related multimedia content A14 and the related multimedia content A15 according to the search condition. The related multimedia content A11, the related multimedia content A12, the related multimedia content A14 and the related multimedia content A15 are, for example, the 11^{th} episode of the Japanese TV drama, the 12^{th} episode of the Japanese TV drama, the 14^{th} episode of the Japanese TV drama and the 15^{th} episode of the Japanese TV drama, respectively.

The analysis module 32 analyzes the reliabilities and the real links of the related multimedia content A11, the related multimedia content A12, the related multimedia content A14 and the related multimedia content A15 so as to generate a related playlist 230 according to the original multimedia content A13c, the related multimedia content A11, the related multimedia content A12, the related multimedia content A14 and the related multimedia content A15. The analysis module 32 can generate a multi-playlist 70 shown in FIG. 7, according to the original playlist 210, the related playlist 220 and the related playlist 230. The method of generating the related playlist 220 has been described hereinabove, and detailed descriptions thereof will be omitted.

Although the invention has been described according to several embodiments, any modification is still deemed as falling within the scope of the invention as long as the related playlist is generated according to the original playlist regardless of whether there is one or more related playlists, and whether the related multimedia content is one fragment or a whole episode.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multi-playlist generating system, comprising:
a search module for receiving an original playlist comprising an original multimedia content, and searching a related multimedia content, relating to the original multimedia content, according to a search condition; and
an analysis module for analyzing the related multimedia content and generating a related playlist according to the original multimedia content and the related multimedia content.

2. The system according to claim 1, further comprising:
a control module for associating the related multimedia content with an operation message, and controlling a play content of the related playlist according to the operation message; and
a receiving module for receiving the operation message, which is inputted by a user, and transferring the operation message to the control module.

3. The system according to claim 1, further comprising:
a timer for recording a play time of the original multimedia content, wherein the search module searches the related multimedia content when the play time of the original multimedia content reaches a predetermined time.

4. The system according to claim 1, wherein the search condition comprises a first search condition and a second search condition, the related multimedia content comprises a first related multimedia content and a second related multimedia content, the related playlist comprises a first related playlist and a second related playlist, the search module searches the first related multimedia content according to the first search condition, the analysis module generates the first related playlist according to the original multimedia content and the first related multimedia content, the search module searches the second related multimedia content according to the second search condition, and the analysis module generates the second related playlist according to the original multimedia content and the second related multimedia content.

5. The system according to claim 1, wherein the search condition is one or a combination of a program name, an uploader name, and a website address.

6. The system according to claim 1, wherein the analysis module further analyzes a reliability and a real link of the related multimedia content.

7. A method for generating a multi-playlist, the method comprising the steps of:
receiving an original playlist comprising an original multimedia content, and searching a related multimedia content, relating to the original multimedia content, according to a search condition; and
analyzing the related multimedia content and generating a related playlist according to the original multimedia content and the related multimedia content.

8. The method according to claim 7, further comprising the steps of:
associating the related multimedia content with an operation message;
receiving the operation message; and
controlling a play content in the related playlist according to the operation message.

9. The method according to claim 7, further comprising the steps of:
recording a play time of the original multimedia content, and searching the first related multimedia content when the play time of the original multimedia content reaches a predetermined time.

10. The method according to claim 7, wherein the search condition further comprises a first search condition and a second search condition, the related multimedia content comprises a first related multimedia content and a second related multimedia content, the related playlist comprises a first related playlist and a second related playlist, the step of searching comprises:
searching the first related multimedia content according to the first search condition, and searching the second related multimedia content according to the second search condition;
wherein the step of analyzing comprises:
generating the first related playlist according to the original multimedia content and the first related multimedia content, and generating the second related playlist according to the original multimedia content and the second related multimedia content.

11. The method according to claim 7, wherein the search condition is one or a combination of a program name, an uploader name and a website address.

12. The method according to claim 7, wherein the step of analyzing further comprises analyzing a reliability and a real link of the related multimedia content.
